(19) United States
(12) Patent Application Publication
(10) Pub. No.: US 2025/0315723 A1
(43) Pub. Date: Oct. 9, 2025

(54) AI-POWERED ADAPTIVE PERFORMANCE

(71) Applicant: Dell Products L.P., Round Rock, TX (US)

(72) Inventor: Mahuya Ghosh, Telangana (IN)

(73) Assignee: Dell Products L.P., Round Rock, TX (US)

(21) Appl. No.: 18/630,174

(22) Filed: Apr. 9, 2024

(51) Int. Cl. G06N 20/00; G06N 5/022

(52) U.S. Cl. CPC G06N 20/00; G06N 5/022

(57) ABSTRACT

Methods and systems for federated caching with intelligent content delivery network (CDN) optimization are disclosed. A caching system collects data relating to one or more user's interactions with an application. Machine learning (M/L) models analyze and train on the usage data to predict user behavior patterns, application performance trends and potential data roadblocks. The predicted outputs may be used to generate an adaptive performance policy configured to enable proactive caching decisions and system performance optimizations.

### BACKGROUND

Traditional content delivery networks (CDNs) often rely on centralized caching, which can lead to suboptimal performance due to limited knowledge of user preferences and dynamic content changes. Additionally, privacy concerns arise when trying to collect and analyze user data for improving caching strategies. There is a need for a more intelligent and privacy-preserving approach to caching that can adapt to evolving user demands and content popularity.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method of storing data may include receiving a user input to an application and generating a first training sample from the user input. A first learning model may be trained on the first training sample. The first learning model may be further trained on a plurality of training samples from a plurality of user inputs and configured to output an application behavior prediction. A second learning model may be trained on the application behavior prediction. The second learning model may be further trained on a plurality of application behavior predictions and configured to output a predicted adaptive performance policy. An adaptive performance policy may be generated based on the application behavior prediction and the predicted adaptive performance policy.

The method may further include, alone or in combination, one or more of the following features. The second learning model may include a reinforcement learning model. The first learning model includes a federated learning model. The plurality of training samples may be obtained from decentralized data sources. The application behavior prediction may be generated according to at least one of a user behavior pattern, an application performance trend, and a potential operation bottleneck. The second learning model may include a deep q-network (DQN). The predicted adaptive performance policy may include a cache strategy. The cache strategy may include at least one of a content identification policy, a content eviction policy, and a content storage location policy. The adaptive performance policy may be generated in real-time based on an update to at least one of the first learning model or the second learning model.

According to another aspect, a system may include a memory and at least one processor that is operatively coupled to the memory. The at least one processor may be configured to perform the operations of receiving a user input to an application and generating a first training sample from the user input. A first learning model may be trained on the first training sample. The first learning model may be further trained on a plurality of training samples from a plurality of user inputs and configured to output an application behavior prediction. A second learning model may be trained on the application behavior prediction. The second learning model may be further trained on a plurality of application behavior predictions and configured to output a predicted adaptive performance policy. An adaptive performance policy may be generated based on the application behavior prediction and the predicted adaptive performance policy.

The system may include, alone or in combination, one or more of the following features. The second learning model may include a reinforcement learning model. The first learning model includes a federated learning model. The plurality of training samples may be obtained from decentralized data sources. The application behavior prediction may be generated according to at least one of a user behavior pattern, an application performance trend, and a potential operation bottleneck. The second learning model may include a deep q-network (DQN). The predicted adaptive performance policy may include a cache strategy. The cache strategy may include at least one of a content identification policy, a content eviction policy, and a content storage location policy. The adaptive performance policy may be generated in real-time based on an update to at least one of the first learning model or the second learning model.

According to another aspect, a non-transitory computer-readable medium may store one or more processor-executable instructions, which when executed by at least one processor cause the at least one processor to perform the operations of receiving a user input to an application and generating a first training sample from the user input. A first learning model may be trained on the first training sample. The first learning model may be further trained on a plurality of training samples from a plurality of user inputs and configured to output an application behavior prediction. A second learning model may be trained on the application behavior prediction. The second learning model may be further trained on a plurality of application behavior predictions and configured to output a predicted adaptive performance policy. An adaptive performance policy may be generated based on the application behavior prediction and the predicted adaptive performance policy.

The non-transitory computer-readable medium may further include one or more processor-executable instructions in which the first learning model may include a federated learning model and the second learning model may include a reinforcement learning model.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a storage system, according to one or more aspects of the present disclosure;

FIG. 1B is a diagram of an example of a storage processor, according to one or more aspects of the present disclosure;

FIG. 2 is a flow diagram of a machine learning caching strategy, according to one or more aspects of the present disclosure;

FIG. 3 is a block diagram of an intelligent caching system, according to one or more aspects of the present disclosure;

FIG. 4 is a flow diagram of a method of training machine learning models, according to one or more aspects of the present disclosure; and

FIG. 5 is a diagram of an example of a computing device, according to aspects of the disclosure.

### DETAILED DESCRIPTION

Aspects of the present disclosure include methods and systems for federated caching with intelligent content delivery network (CDN) optimization. In a business-to-business (B2B), business-to-consumer (B2C) or other consumer-facing application architecture, a caching system may collect data relating to one or more user's interactions with an application. Machine learning (M/L) models may analyze and train on the usage data to predict user behavior patterns, application performance trends and potential data roadblocks. The predicted outputs may be used to generate a real-time adaptive performance policy configured to enable proactive caching decisions and system optimizations. Methods and systems for storing data may combine the power of federated artificial intelligence (AI) and caching mechanisms to create an intelligent CDN that adapts to user demands and network conditions. By leveraging distributed knowledge and predictive analytics, the disclosed methods and systems may optimize content delivery, reduce network latency, and improve the overall user experience.

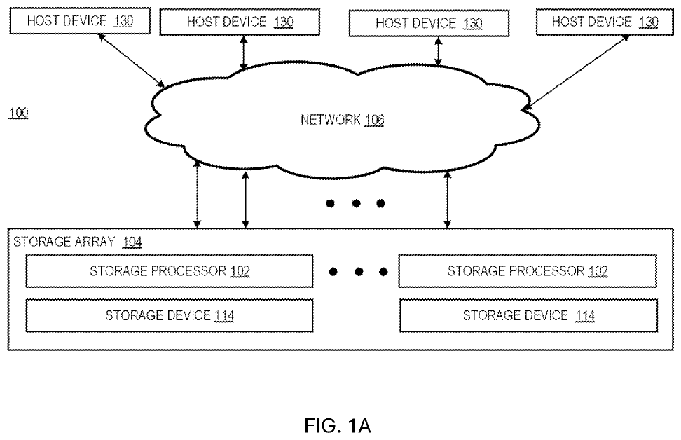

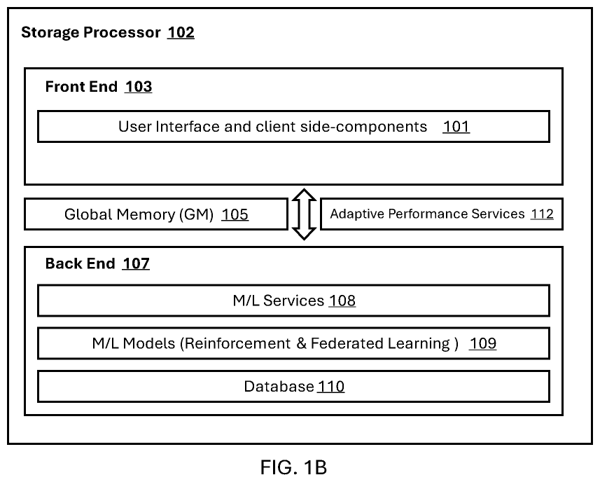

FIG. 1A is a diagram of an example of a CDN system 100, according to aspects of the disclosure. As illustrated, the CDN system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include or be arranged with one or more storage processors 102 and a plurality of non-volatile memory storage devices 114. Each of the storage processors 102 may be configured to receive Input/Output (I/O) requests from host devices 130 and execute the received I/O requests by reading and/or writing data to storage devices 114. According to one aspect, the storage array 104 may include or define one or more edge nodes. Each of the host devices 130 may include a desktop computer, a laptop, a smartphone, an internet-of-things (IoT) device, and/or any other suitable type of computing device.

According to one aspect, the CDN system may include a B2B, B2C, architecture or other consumer-facing application. Interactions between users' host devices 130 and storage arrays 104 may include a micro-frontend (MFE)-based architecture and/or a commercial cloud platform, such as Pivotal Cloud Foundry (PCF), or the like.

FIG. 1B is a diagram of an example of a storage processor 102, according to aspects of the disclosure. As illustrated, the storage processor 102 may include a front end module 103 featuring a user interface and client-side components 101. The front end 103 may be responsible for caching in global memory (GM) 105 data associated with incoming requests. Additionally, the front end 103 may handle or process administrative settings to configure cache settings, monitor cache performance and view cache and system analytics. The front end 103 may further process and/or generate real-time system notifications and alerts for cache-related events. A back end module 107 may include, among other functionalities, machine learning (M/L) services 108, M/L models 109 and a database 110. According to one aspect, the M/L models 108 may include a federated learning model and a reinforcement learning model, described in further detail below.

The back end 107 may be responsible for destaging the data from GM 105 into the storage devices 114 (FIG. 1A). In addition, the back end 107 may be responsible for loading, into the GM 105, data associated with incoming read requests, and the front end 103 may be responsible for returning the cached data to the senders of the read requests. The front end 103 and back end 107 may be implemented as various services (or kernel components) of the storage processors 102.

Adaptive performance services 112 may include a services layer to provide application programming interfaces (APIs) to enable seamless integration of an adaptive performance policy with front end 103 applications and systems, such as a B2B, B2C or other commercial platform.

According to aspects of the disclosure, described in detail below, the M/L services 108, M/L models 109 and database 110 of the back end module 107 may operate in conjunction with the adaptive performance services 112 to provide an adaptive performance policy configured to proactively cache data and optimize both system and content delivery, thereby enhancing system performance in a tangible and practical manner. Each storage processor 102, or CDN node, may incorporate federated learning capabilities, allowing them to collaborate and collectively learn from user interactions and content popularity across different regions. The aggregation and analysis of the distributed knowledge may allow the storage processors 102 to dynamically adjust caching strategy to optimize content placement and improve cache hit rates. As described herein, intelligent content prefetching mechanisms based on user behavior patterns and predictive analytics may also be employed.

According to another aspect, as described herein, the adaptive performance policy generated by the M/L services 108 may be configured to automatically invalidate or update the cached content upon a new deployment or release, relieving end users of having to manually clear their cache. According to one aspect, the caching system, implemented according to the adaptive performance policy, may handle the cache invalidation or refresh process seamlessly, ensuring that users receive the most up-to-date content without requiring any manual intervention.

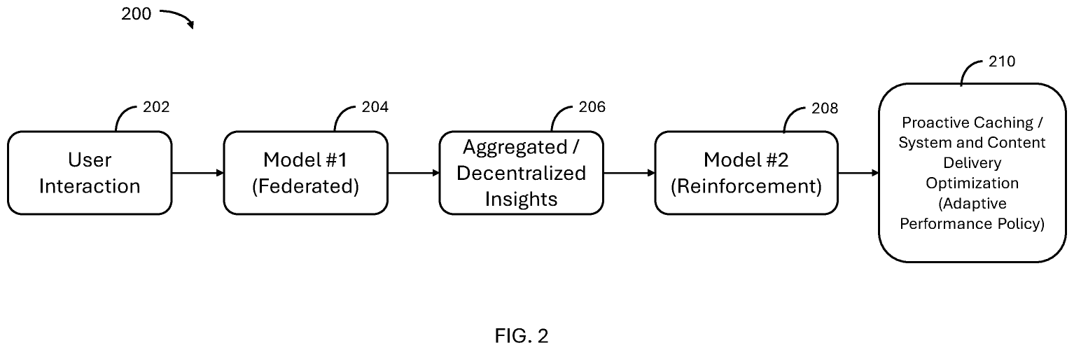

FIG. 2 is a flow diagram of a machine learning caching strategy 200, according to one or more aspects of the present disclosure. The strategy 200 may begin with user interaction 202. For example, a user may interact with an application, such as a website. Metrics and measurements related to the user's interactions with the application may be captured, as a clickstream or the like, and include content metadata including, without limitation, content type, size, a popularity rating, or the like. Application performance metrics may also be captured, including for example, response times, latency, or the like.

According to one aspect, user interaction data and application performance data may be input into one or more M/L models. For example, a federated M/L model 204 (e.g., Model #1) may receive the user interaction data. According to one aspect, the federated M/L model 204 may include a library, such as TensforFlow Federated (TFF) library, and include federated averaging to enable training on decentralized data sources while preserving data privacy and security. Federated learning may aggregate insights from multiple devices or organizations without directly accessing raw data.

The use of the federated M/L model 204 may provide for training a central model across decentralized devices or servers, where, rather than moving all data to a central location, the model may be trained locally on each device (e.g., CDN edge node). Accordingly, only the model updates are shared across the system as aggregated and decentralized insights 206 from multiple devices, applications, organizations or the like, without accessing the raw data. The federated nature of the model protects privacy and allows collaborative learning without sharing raw data. The federated M/L model 204 may be trained and configured to predict user behavior patterns, application performance trends, and potential bottle necks in the cache flow. The federated M/L model predictions may be used to generate and maintain the adaptive performance policy and enable proactive caching decisions and system optimizations.

According to one aspect, the aggregated and decentralized insights 206 may be used as inputs to a second M/L model 208 (e.g. Model #2). The second M/L model 208 may be or include a reinforcement learning model trained on user feedback and performance metrics (i.e., the aggregated and decentralized insights 206) obtained from the federated M/L model 204. According to one aspect, the second M/L model 208 may include a library, such as a TensorFlow library, and a deep Q-network (DQN) trained to predict optimal caching strategies. The second M/L model 208 may be configured to output optimized proactive caching and system and content delivery optimization strategies in the form of an adaptive performance policy 210. The second M/L model may provide insights for efficient content caching, determining which content to store, when to evict content, and where to place content for optimal performance. According to one aspect, as described herein, the second M/L model may be configured to dynamically adjust content placement and eviction policies according to the adaptive performance policy. As described herein, the M/L models may be configured to continuously learn from user interactions and adapt caching strategies in real-time, ensuring responsive and personalized content delivery.

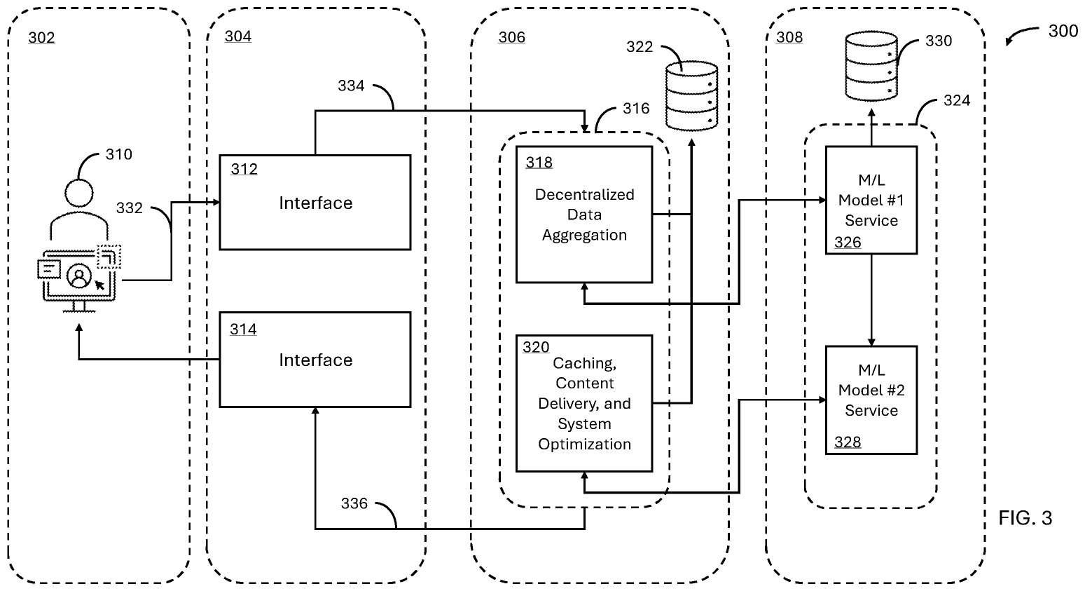

FIG. 3 is a block diagram of an intelligent caching system 300, according to one or more aspects of the present disclosure. The system 300 may include a user space 302, a front end space 304, an adaptive performance space 306 and a M/L space 308. As shown in FIG. 3, each of the conceptual spaces may be involved in intelligently processing cache operations for consumer-facing applications, or the like.

According to one aspect, the user space may include a user computing device 310, such as a host device 130 (FIG. 1A), configured to access and interact with an application, over a network, to engage in a transaction, commercial or otherwise. The user computing device may invoke the application which may be provided through the front end space 304. The front end space 304 may include the applications with which the user may interact. For example, a first interface 312 may be provided to the user, via a web browser, widget or application, with which the user may interact. The user interactions with the first interface 312 may include clickstream data and behavior patterns, as well as metadata related to content, including content type, size, popularity, or the like. As the user interacts with the system, the user interaction data and the content metadata, along with other application-level metrics, including data such as response time and latency, may be input to a first loop 316 in the adaptive performance space 306. The first loop 316 may include a decentralized data aggregation module 318 and a caching, content delivery, and system optimization module 320.

According to one aspect, the decentralized data aggregation module 318 and a caching, content delivery, and system optimization module 320 may include APIs to enable integration of the adaptive performance functionalities generated in the M/L space 308. The front end space 304 is then able to render the content and complete the user's actions in an observable fashion (i.e., improved application performance) through the interface, shown here as a second interface 314. For example, the user may begin interacting with the application, shown by arrow 332. The actions requested by the user, for example in the form of I/O requests, may be processed and cached according to the functionalities of the adaptive performance space 306, shown by arrow 334. After the requests are processed according to the adaptive performance policy, content may be rendered and the user's requested actions may be performed, shown by arrow 336. One skilled in the art will recognize that the first interface 312 and the second interface 314 may be the same interface, however, they are depicted as two interfaces for the ease of describing the system and its functionalities.

As described herein, the decentralized data aggregation module 318 may collect the user interactions and metadata in a decentralized manner. Such data may be stored in a first database 322. The decentralized data aggregation module 318 may rely on the services of the M/L space 308. The M/L space 308 may include a second loop 324 having a M/L Model #1 service 326 and a M/L Model #2 service 328. A second database 330 may be part of the M/L space 308 as a mechanism for storing the M/L models and associated data. The decentralized data aggregation module 318 may call the M/L Model #1 service 326, including a federated learning model, and its machine learning processes to analyze cache usage patterns and provide intelligent recommendations for caching strategies in a decentralized and secure manner.

According to one aspect, and as described herein, the federated M/L Model #1 service 326 may output the predicted user behavior patterns, application performance trends, and potential bottlenecks and input that data to the M/L Model #2 service 328, which may include a reinforced learning model. The M/L Model #2 service may use the reinforcement learning model to generate insights and predictions to generate a real-time adaptive performance policy for managing the caching system. The caching, content delivery and system optimization 320 may execute the adaptive performance policy which may implement caching rules and processes including, without limitation, determining which content to store, when to evict content, and where to place content for optimal performance. In keeping with the design and functionalities as delineated, the system further incorporates a dynamic learning component within the M/L Model #2 service 328. This component may leverage continuous input from user interactions to refine and adapt its operational parameters. Through the assimilation of real-time data, the reinforcement learning model within M/L Model #2 may be engineered to perpetually evolve, enhancing its capability to devise and recalibrate the adaptive performance policy. This ensures that the caching system remains not only anticipatory but also well-attuned to the fluidity of user demands and system requirements, thereby facilitating an ever responsive and bespoke content delivery framework.

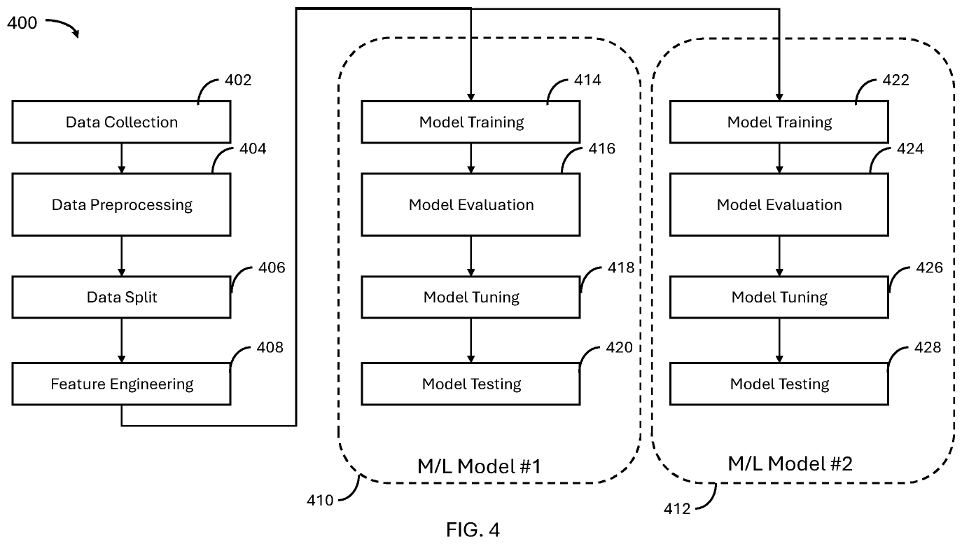

FIG. 4 is a flow diagram of a method 400 of training machine learning models, according to one or more aspects of the present disclosure. As shown in block 402, training datasets may begin by collecting interaction data. The interaction data may include user interactions and content popularity data collected from the CDN nodes. For example, data collection may involve gathering and storing content metadata and application performance metrics. The content metadata may include data such as content type (e.g., article), a content size (e.g., 10 MB), and a popularity rating (e.g., high). Application performance metrics may include, without limitation response times and latency.

As shown in block 404, the collected data may be data preprocessed where the collected data may be scrubbed, missing values corrected or otherwise accounted for, and transformed into a usable training sample format. For example, content metadata may have categorical variables encoded while application performance data may have its values normalized. After preprocessing, the data may be split, shown in block 406. The collected and preprocessed data may be split into training datasets, validation datasets and testing datasets. For example, 70% of the collected data may be used for training the model, 15% may be used to validate the model, and 15% may be used to test the model. As shown in block 408, the data may undergo feature engineering to extract relevant features, such as extracting content attributes from the content metadata and creating performance metrics from the application performance data.

After the feature engineering, the models may be trained on the training samples generated (i.e., the training data set). As shown in block 410 the first model, for example the federated learning model, may be trained in parallel to the second model, shown in block 412. However, one skilled in the art will recognize that the models may be trained in any order or concurrently. Shown in blocks 414 the first model, a federated learning model, may be trained on distributed user data to ensure the preservation of data privacy and security. The second model, shown in block 422 may be trained using reinforcement learning techniques. For example, the second model may be trained with a Q-learning algorithm with reward-based caching.

Once the models have been initially trained, they may be evaluated using the validation dataset. The performance of the first learning model may be evaluated, shown in block 416, on local data while the second model may be evaluated, shown in block 424, based on an average reward per interaction. The models may then be fine tuned to improve performance. The first learning model may be tuned, shown in block 418, with local model updates and aggregation optimized. The second model, shown in block 426, may have an exploration/exploitation tradeoff tuned by adjusting an exploration factor and fine-tuning a rate and discount factor. The models may then be tested using the testing dataset. The first learning model, shown in block 420 may be tested to predict user behavior or application performance using the local models. As shown in block 428, the second model may be tested by applying optimized caching strategies. Once the models have been sufficiently tested, an adaptive performance policy may be generated and applied such that user interactions are cached according to the policy. According to one aspect, the first learning model and the second learning model may be adapted in real-time as users interact with the application. The models may continuously learn from and be trained on user interactions and dynamically adapt caching strategies in the adaptive performance policy in real-time, ensuring responsive and personalized content delivery.

One skilled in the art will recognize that while certain steps for training the first and second models are shown together, for example in blocks 402-408, the data collected, preprocessed, split and engineered may not be the same data for both models and that blocks 402-408 are shown as joint steps for each model for ease of demonstration and explanation.

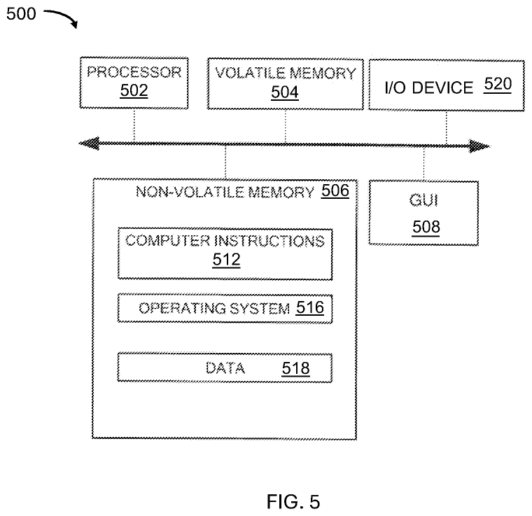

FIG. 5 is a diagram of an example of a computing device, according to aspects of the disclosure. In some embodiments, a computing device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

FIGS. 1-5 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-6 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method of storing data, the method comprising:
receiving a user input to an application;
generating a first training sample from the user input;
training a first learning model on the first training sample, the first learning model further trained on a plurality of training samples from a plurality of user inputs and configured to output an application behavior prediction;
training a second learning model on the application behavior prediction; the second learning model trained on a plurality of application behavior predictions and configured to output a predicted adaptive performance policy; and
generating an adaptive performance policy based on the application behavior prediction and the predicted adaptive performance policy.

2. The method of claim 1 wherein the second learning model includes a reinforcement learning model.

3. The method of claim 1 wherein the first learning model includes a federated learning model.

4. The method of claim 3 wherein the plurality of training samples is obtained from decentralized data sources.

5. The method of claim 1 wherein the application behavior prediction is generated according to at least one of a user behavior pattern, an application performance trend, and a potential operation bottleneck.

6. The method of claim 1 wherein the second learning model includes a deep q-network (DQN).

7. The method of claim 1 wherein the predicted adaptive performance policy includes a cache strategy.

8. The method of claim 7 wherein the cache strategy includes at least one of a content identification policy, a content eviction policy, and a content storage location policy.

9. The method of claim 1 further comprising generating the adaptive performance policy in real-time based on an update to at least one of the first learning model or the second learning model.

10. The method of claim 1 further comprising training at least one of the first learning model and the second learning model in real-time based on continuous user input.

11. A system comprising:
a memory; and
at least one processor that is operatively coupled to the memory, the at least one processor being configured to perform the operations of:
receiving a user input to an application;
generating a first training sample from the user input;
training a first learning model on the first training sample, the first learning model further trained on a plurality of training samples from a plurality of user inputs and configured to output an application behavior prediction;
training a second learning model on the application behavior prediction; the second learning model trained on a plurality of application behavior predictions and configured to output a predicted adaptive performance policy; and
generating an adaptive performance policy based on the application behavior prediction and the predicted adaptive performance policy.

12. The system of claim 11 wherein the second learning model includes a reinforcement learning model.

13. The system of claim 11 wherein the first learning model includes a federated learning model.

14. The system of claim 13 wherein the plurality of training samples is obtained from decentralized data sources.

15. The system of claim 11 wherein the application behavior prediction is generated according to at least one of a user behavior pattern, an application performance trend, and a potential operation bottleneck.

16. The system of claim 11 wherein the second learning model includes a deep q-network (DQN).

17. The system of claim 11 wherein the predicted adaptive performance policy includes a cache strategy.

18. The system of claim 17 wherein the cache strategy includes at least one of a content identification policy, a content eviction policy, and a content storage location policy.

19. The system of claim 11 further comprising generating the adaptive performance policy in real-time based on an update to at least one of the first learning model or the second learning model.

20. A non-transitory computer-readable medium storing one or more processor-executable instructions, which when executed by at least one processor cause the at least one processor to perform the operations of:
receiving a user input to an application;
generating a first training sample from the user input;
training a first learning model on the first training sample, the first learning model further trained on a plurality of training samples from a plurality of user inputs and configured to output an application behavior prediction;
training a second learning model on the application behavior prediction; the second learning model trained on a plurality of application behavior predictions and configured to output a predicted adaptive performance policy; and
generating an adaptive performance policy based on the application behavior prediction and the predicted adaptive performance policy.
